(19) United States
(12) Patent Application Publication
(10) Pub. No.: US 2009/0129095 A1
(43) Pub. Date: May 21, 2009

(54) ILLUMINATION SYSTEM

(75) Inventors: HSIN-TSUNG YEH, Tu-Cheng (TW); CHUN-HSIANG HUANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/171,258

(22) Filed: Jul. 10, 2008

(30) Foreign Application Priority Data
Nov. 20, 2007 (CN) 200710202603.X

(51) Int. Cl. F21V 7/00

(52) U.S. Cl. 362/307

(57) ABSTRACT

An illumination system includes an LED and a solid light pipe. The solid light pipe includes an incident surface, an emitting surface opposite to the incident surface, and four reflecting side surfaces joining the incident surface and the emitting surface. An area of the incident surface is smaller than an area of the emitting surface. The LED is positioned in front of the incident surface of the solid light pipe.

### TECHNICAL FIELD

The present invention relates to an illumination system, and more particularly, to an illumination system with uniform projection luminance.

### BACKGROUND

Light emitting diodes (LEDs) with high luminance have been widely applied as a light source in many kinds of illumination systems. Generally, in a directional illumination system, a spherical or an aspherical reflecting lamp cover is employed to reflect and/or focus the light beams emitted from the LED. However, it is relatively difficult and complex to manufacture spherical and aspherical reflecting lamp covers. In addition, it is difficult for the spherical or aspherical reflecting lamp covers to accurately control an emitting angle of the light beams emitted from the LEDs. Furthermore, it is difficult for the illumination system to get an uniform luminance by employing the reflecting lamp covers.

Therefore, there is a need to find an illumination system with uniform projection luminance or brightness for solving above-mentioned problems.

### SUMMARY

An illumination system is disclosed. The illumination system includes an LED and a solid light pipe. The solid light pipe includes an incident surface, an emitting surface opposite to the incident surface, and four reflecting side surfaces joining the incident surface and the emitting surface. An area of the incident surface is smaller than an area of the emitting surface. The LED is positioned in front of the incident surface of the solid light pipe.

### BRIEF DESCRIPTION OF THE DRAWINGS

Many aspects of the present illumination system can be better understood with reference to the following drawings. The components in the drawing are not necessarily drawn to scale, the emphasis instead being placed upon clearly illustrating the principles of the present assembly of the illumination system.

FIG. 1 is a schematic isometric view of an illumination system, according to an exemplary embodiment.

FIG. 2 is a schematic view of the illumination range of the illumination system of FIG. 1.

FIG. 3 is a schematic light path diagram of the illumination system of FIG. 1.

### DETAILED DESCRIPTION OF THE EMBODIMENTS

Embodiments of the present invention will now be described in detail below, with reference to the drawings.

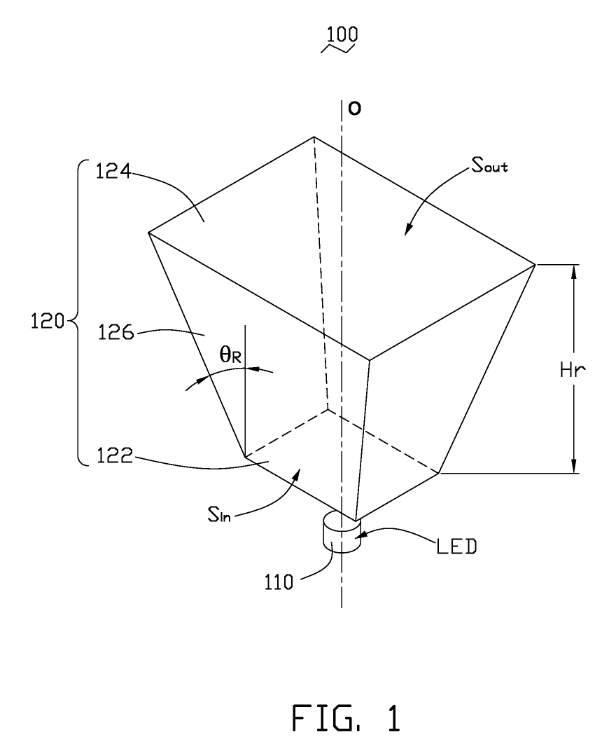

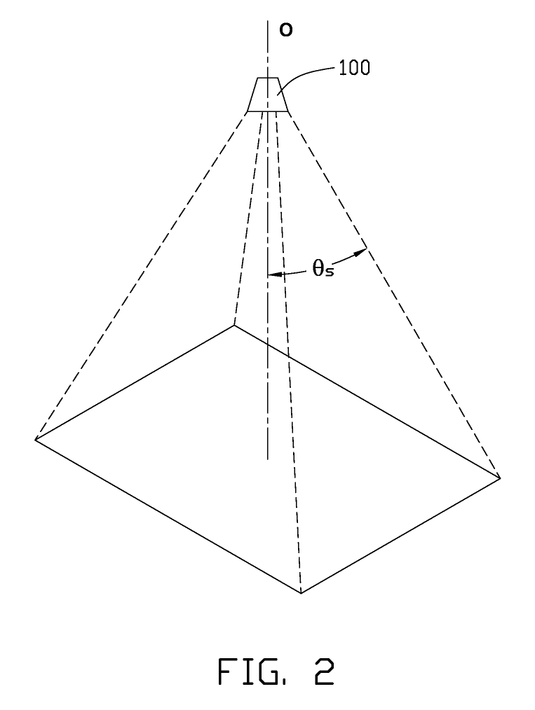

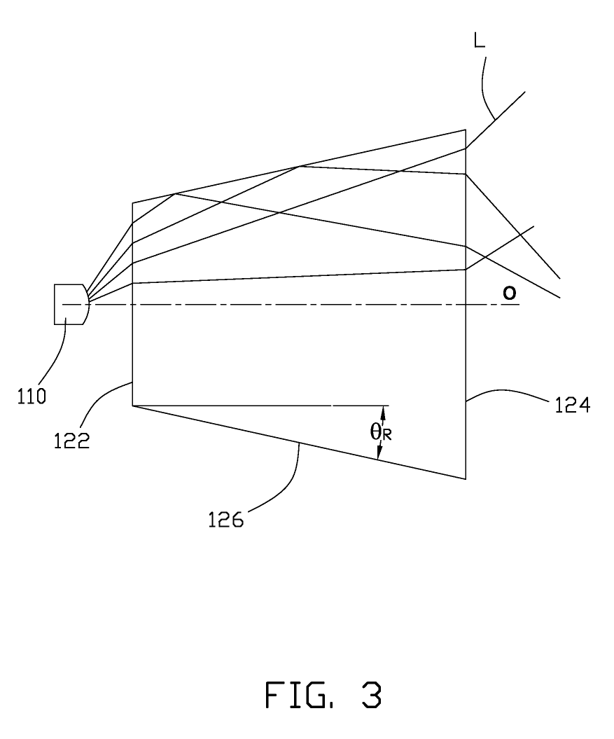

Referring to FIGS. 1-3, FIG. 1 is a schematic isometric view of an illumination system 100 according to an exemplary embodiment, FIG. 2 is a schematic view of an illumination range of the illumination system 100 of FIG. 1, and FIG. 3 is a schematic light path diagram of the illumination system 100 of FIG. 1. The illumination system 100 according to an exemplary embodiment includes an LED 110 and a light pipe 120.

The LED 110 is employed as a light source for the illumination system 100.

The light pipe 120 is a solid pipe, which is shaped as a frustum of a rectangular pyramid. The light pipe 120 includes an incident surface 122, an emitting surface 124 opposite and parallel to the incident surface 122, and four reflecting side surfaces 126 joining the incident surface 122 and the emitting surface 124. The light pipe 120 is made of transparent material, such as glass or quartz etc.

In the exemplary embodiment, the incident surface 122 and the emitting surface 124 are both shaped as regular squares. The areas of the incident and emitting surfaces 122, 124 are respectively designated as S-in and S-out. S-in is smaller than S-out. A distance between the incident surface 122 and the emitting surface 124 is designated as Hr. The light pipe 120 has an optical axis O which is perpendicular to the incident surface 122 and the emitting surface 124 substantially. An angle between each of the reflecting surfaces 126 and the optical axis O is designated as θ_{R}. Understandably, the angle θ_{R} is greater than zero (θ_{R}>0). Advantageously, the angle θ_{R} satisfies the following inequation: 5°<θ_{R}<15°. Accordingly, the scattering angle θ_{S} (shown in FIG. 2) of light beams emitted from the emitting surface 124 of the light pipe 120 relative to the optical axis O advantageously satisfies the following inequation: 2θ_{R}<θ_{S}<5θ_{R}. Understandably, the angle θ_{R} can vary according to the variation of the angle θ_{S} to satisfy varied needs.

The light pipe 120 is an optically denser medium with higher refractive index than that of ambient air which is an optically thinner medium. When light beams irradiated from the LED 110 enter into the light pipe 120 via the incident surface 122, a part of the light beams parallel to the optical axis of the light pipe 120 emit from the emitting surface 124 directly without refraction, and the remainder of the light beams are reflected by the reflecting surfaces 126. Those light beams incident on the reflecting surface 126 are partially refracted at the boundary between the light pipe 120 and air surrounding the light pipe 120, and partially reflected. It is well known that if light beams enter from an optically denser medium to an optically thinner medium, light beams which have an incident angle larger than the critical angle of the interface between the two mediums, those light beams will be totally reflected at the interface between the two mediums. Understandably, in the present embodiment, because the area of the incident surface 122, S-in, is smaller than that of the emitting surface 124, S-out, the incident angle of the light beams irradiated from the LED 110 incident on the reflecting surfaces 126 are enlarged so that the light beams is capable of being totally reflected on the reflecting surfaces 126 easily. As a result, usage efficiency of the light beams is improved. Thus, the luminance of the illumination system is enhanced. Understandably, the more light beams reflected by the reflecting surface 126 into the light pipe 120, the better the uniformity and enhancement of the luminance of the illumination system 100. Advantageously, when following the above described inequations, most of the light beams incident on the reflecting surfaces 126 have incident angles, with respect to the reflecting surface 126, larger than the critical angle of the interface between the light pipe 120 and the ambient air. Therefore, most of the light beams incident on the reflecting surfaces 126 will be totally reflected between the reflecting surfaces 126 and then emit out of the emitting surface 124. As a result, improved uniformity and enhancement of the luminance of the illumination system 100 is achieved.

In addition, the distance Hr between the incident surface 122 and the emitting surface 124 is advantageously configured longer than a side length of the incident surface 122 to provide a light path long enough for the light beams to travel therein to achieve a uniform luminance of the illumination system 100.

Understandably, the shapes or profiles of the incident surface 122 and the emitting surface 124 can be changed to other shapes or profiles depending on desires of the users, such as circular, ellipsoidal, rectangular and so on. In addition, the incident surface 122 and/or the emitting surface 124 may be designed as curved surfaces.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An illumination system comprising:
a solid light pipe comprising:
an incident surface;
an emitting surface opposite to the incident surface; and
four reflecting side surfaces joining the incident surface and the emitting surface; and
an LED positioned in front of the incident surface of the solid light pipe for emitting light beams to the incident surface;
wherein an area of the incident surface is smaller than an area of the emitting surface.

2. The illumination system as claimed in claim 1, wherein the solid light pipe is shaped as a frustum of a rectangular pyramid.

3. The illumination system as claimed in claim 2, wherein the incident surface is parallel to the emitting surface substantially.

4. The illumination system as claimed in claim 1, wherein an angle θ_{R} of each reflecting surface relative to an optical axis of the solid light pipe perpendicular to the incident surface and the emitting surface is greater than zero.

5. The illumination system as claimed in claim 4, wherein the angle θ_{R} satisfies the following inequation: 5°<θ_{R}<15°.

6. The illumination system as claimed in claim 1, wherein a distance between the incident surface and the emitting surface is longer than a side length of the incident surface.

7. The illumination system as claimed in claim 1, wherein the solid light pipe is made of transparent material.

8. The illumination system as claimed in claim 7, wherein the transparent material is selected from the group of quartz and glass.

9. The illumination system as claimed in claim 1, wherein a refractive index of the solid light pipe is larger than an refractive index of air.

10. The illumination system as claimed in claim 1, wherein the incident surface and emitting surfaces of the solid light pipe are curved surfaces respectively.

11. The illumination system as claimed in claim 1, wherein the incident surface and the emitting surface of the solid light pipe are shaped as one in the groups of square, rectangular, circular and ellipsoidal.

12. The illumination system as claimed in claim 4, wherein a scattering angle θ_{S} of light beams emitted from the emitting surface of the solid light pipe relative to the optical axis of the light pipe satisfies the following inequation: 2θ_{R}<θ_{S}<5θ_{R}.
